(19) United States
(12) Patent Application Publication
(10) Pub. No.: US 2020/0242230 A1
(43) Pub. Date: Jul. 30, 2020

(54) Password recovery device and method

(71) Applicant: Tamara Bell, San Diego, CA (US)

(72) Inventor: Tamara Bell, San Diego, CA (US)

(21) Appl. No.: 16/258,622

(22) Filed: Jan. 27, 2019

(51) Int. Cl. G06F 21/45; G06F 21/36

(52) U.S. Cl. CPC G06F 21/45; G06F 21/36

(57) ABSTRACT

The invention includes a set of wearable accessories and methods that generate and recover passcodes. Figures may be displayed on one side of each accessory and digits displayed on another side as associated pairs. When the digits across the set of accessories are aligned, the associated figures form a password string. The accessories may be aligned by dialing the digits according to a memory string. The user may recover this password string at any time by recalling the memory string and dialing the accessories to match the memory string.

### BACKGROUND

Field of the invention: The invention relates to devices and methods that generate and recover passwords.

Passwords have been developed as a method of ensuring secure entrance to a website. The past few years have shown an increased need for more robust passwords as consumers and employees use websites that store personal identification data, credit card information, and sensitive company information. The rules that govern password generation for various websites usually require the use of a certain character length, special characters, capitalization, and digits. Some websites require the generation of new passwords every so often to further solidify security. These rules create a two-fold problem. First, the rules are established in a manner that make the password more susceptible to hacking. The rules are predictable and computer programs have an easier time cracking passwords that follow a particular protocol. Second, the set of rules are sufficiently complicated to make it difficult for the user to remember their chosen password. Users may resort to recording the password in an attempt to remember it for future use. Still others may oversimplify their password choice, choosing a favorite sports team or easy sequence of digits. These actions decrease the security of their passwords and leave them vulnerable to hacking. In general, the most easily recalled passwords are often the most easily hacked.

In the past, the use of smartphones and device applications have provided one method of generating and recovering passwords. Typically, the application requires the user to remember a single password to unlock the application before a randomized password for a particular website is generated. This password may now be copied and pasted or used outright in a website login.

This method presents several issues to the user. One, the application requires that the user still remember a complicated password to enter the application. Two, the passwords generated for each website are complicated to provide better security. These complicated websites are therefore not easily recalled and require the user to enter the application each time before logging in to the website of their choice. This is a cumbersome process that may lead the user to resort to recording the password in some fashion, leaving them vulnerable to password theft. Three, as the application is located electronically on the user's cellphone or device, it is susceptible to hacking. Four, many users may feel uncomfortable giving the key to their personal data to the application company for potential use against them in the case of advertising. Users may feel uncomfortable giving away the key password to the application company because they do not trust the companies' security strength against malicious personal identification data theft. The recent spate of data breaches across many of the well-established companies does not inspire trust. Five, as these applications are only available on personal smartphones, or devices, they are not easily transcribed to a company website for employees. Furthermore, companies may balk at the use of these applications being used on their sensitive company databases and websites for reasons of entrusting an unknown entity with their data and the intrinsic security vulnerability of these electronic and online applications.

Another more recent method of password generation and recovery is similar to the application method above with the use of a fingerprint or other biometric authorization as entry into a list of saved passwords. This method uses passwords that the user inelegantly generated and saves them in some manner on the device to be automatically entered to the website of their choice. While more convenient to the method previously described, this method presents several disadvantages. One, the method allows the user to generate their own passwords. These may be unsophisticated and make the users vulnerable to hacking. Two, all of the user's passwords are saved on program or device in some manner that is also vulnerable to hacking, and devastating theft of all their sensitive data. Three, another piece of personal identification data, such as the user's fingerprint, is required and gives both the method company and hackers access to a new and very sensitive piece of personal identification. Many users may feel uncomfortable giving these software companies access to their personal identification data, especially their fingerprints, for undisclosed use. Four, employee websites are still inaccessible with this method on their company computers. Indeed, employers may not welcome the use of such a device and method for entrance into their company databases and websites for reasons of security and unwanted use of the company data.

Another device and method that is not in widespread use that generates and passwords is sold as the RINGminder sold by Russtopia Labs of Courtenay, Canada. The RINGminder takes the form to two size 11 male rings that have the entire English alphabet on the outside surface and a set of special characters or digits that correspond to each letter of the alphabet. The user is instructed to generate a password by recalling the first two letters of the website they would like to enter. The user must locate the first letter of the website on one of the rings and locate the second letter of the website on the other ring. The user is then instructed to read off the two rows of symbols below these located entries. Next, the user must tack on a memorized ‘secret word’ that is complicated with varied capitalization. The two rows of symbols are concatenated with the ‘secret word’ to form the password. A similar device and method are available in a key chain form.

This device and method present several disadvantages. First, in the ring embodiment, there is only one size available, a men's size 11. Perhaps this limitation exists because the alphabet would not be legible if the ring were made smaller. The many users that cannot fit into the single size are instructed to string them on a chain and wear them as a necklace. This singular size limits the potential users and may discourage users from wearing them everywhere which would decrease its usage. Additionally, there is no physical way of distinguishing which is the first ring to be dialed and the second ring to be dialed. Therefore, the user is required to rely on fault-prone memory to distinguish between the two rings to recover the password. Second, in both embodiments of the device, the instructions are long and require the user to rely heavily on their memory. The user must still generate a complicated secret word and tack it onto the end of the dialed entries. Because the user still must remember a complicated ‘secret word,’ the user may be tempted to record their password somewhere, making them more vulnerable to password theft. Third, the use of the English alphabet limits the use of this device in other countries with a different alphabet.

There is a need for a device and method that is not electronic and therefore easily hacked. It requires a piece of actual hardware that worn at all times that does not reveal its passwords to random observers and a method that does not rely heavily upon a user's fault-prone memory. By creating a wearable device that acts as a piece of ornamentation when not in use, the user may happily carry it with them at all times without the threat of hacking. Both the method and the device are needed to generate and recover passwords, creating a barrier to malicious hackers to discern possible passwords. Furthermore, this device requires less reliance on memorizing long and complicated passwords, lessening the need users may feel to record the password in some insecure way. Users may use this device and method to access multiple devices and websites, including employer websites without adding security risk. Additionally, users do not need to make their personal identification information vulnerable or available to companies that provide password generation services.

### SUMMARY

In one type of embodiment, the invention includes a device that has two or more wearables. Each wearable includes an aperture that fits around a body part, such as a finger, a waist, a wrist, or a neck. Each wearable has a set of output surfaces where each output surface displays an output symbol. Each wearable has a set of index surfaces where each index surface displays an index symbol. Each index surface is associated with one of the set of output surfaces. In some embodiments the wearables each have an alignment surface and a receiving surface. The alignment surface of the first wearable is configured to engage the receiving surface of the second wearable.

In some embodiments, the first wearable also includes a cogging feature. The cogging feature may have a magnet, a pole piece, a groove, or a boss. The second wearable includes a second cogging feature that complements the first cogging feature.

In some embodiments, when the wearable is worn by a person, either the set of index symbols or the set of output symbols is obscured.

The first wearable may also include an ordering feature that has one or more of a symbol, a color, a material, a theme, or a shape not present in the second wearable.

In some embodiments, the index surfaces are not continuous with their associated output surfaces.

In still more embodiments, there is a third wearable and a fourth wearable. The third wearable may display a third set of output symbols, and the fourth wearable may display a fourth set of output symbols. In these embodiments, the third set of output symbols is different from the fourth set of output symbols.

In some embodiments, the index symbol of the set of index symbols is a digit.

In another type of embodiment, the invention includes a first wearable and a second wearable. Each wearable may have a plurality of links that form a looped chain. Each wearable may have a plurality of plates with each plate directly connected to a first link of the plurality of links. Each plate may display an output symbol and a unique index symbol. Each plate is further directly connected to a second link of the plurality of links.

In some embodiments, the plate is configured to rotate with respect to another plate of the plurality of plates.

In other embodiments, the first wearable includes an ordering feature that has one or more of a symbol, a color, a material, a theme, or a shape not present in the second wearable.

In still other embodiments there is a third wearable and a fourth wearable. The third wearable may display a third set of output symbols, and the fourth wearable may display a fourth set of output symbols.

In these embodiments, the unique index symbols have a set of index symbols, including digits zero through nine. The set of index symbols are common to each wearable.

The invention includes a method of recovering a passcode by using a set of wearables. Each wearable includes a plurality of index symbols and a plurality of output symbols. In this embodiment, each index symbol may be associated to one of the output symbols. The method includes the following steps:

a. The user recalls a memory string including a sequence of recalled symbols;
b. The user selects a recalled symbol of the sequence of recalled symbols;
c. For each selected recalled symbol, the user:
1. selects a wearable of the set of wearables;
2. locates the index symbol of the selected wearable corresponding to the selected recalled symbol;
3. determines the output symbol associated with the located index symbol; and
4. concatenates the determined output symbol to a password string;
   d. The user repeats steps 2. and 3. for each recalled symbol of the sequence of the recalled symbols.
   e. The user translates each output symbol of the password string into a natural language character string;
   f. The user concatenates each translated character string to recover the passcode.

The method may be used for other embodiments of wearables. In another embodiment, a set of wearables includes a first wearable and a second wearable. The first wearable may have an alignment surface, and the second wearable may have a receiving surface. In such embodiments, the alignment surface may be configured to engage the receiving surface. The method further includes the engagement of the alignment surface to the receiving surface.

In some embodiments, the alignment surface includes a first cogging feature and the receiving surface includes a second cogging feature complementary to the first cogging feature. The method further includes the user rotating the first wearable with respect to the second wearable along the engaged surfaces. The user performs this task to align an index symbol of the first wearable proximate an index symbol of the second wearable.

In some embodiments of the method, each wearable of the set of wearables may include an ordering feature. In this embodiment, the steps of selecting a wearable of the set of wearables may include referring to the ordering feature.

In still another embodiment, the method for the set of wearables may include a multiturn winding.

### BRIEF DESCRIPTION OF DRAWINGS

FIG. 1 is a side view of an embodiment of an accessory set of the invention.

FIG. 2 is perspective view of one accessory of the embodiment of FIG. 1.

FIG. 3 is a perspective view of a second embodiment of a set of accessories.

FIG. 4 is a side view of the embodiment of FIG. 3 in an aligned configuration.

FIG. 5 is a right-side perspective of one accessory of the set of accessories of FIG. 3.

FIG. 6 is a left-side perspective view of a second accessory of the set of accessories of FIG. 3.

FIG. 7a is a front view of one accessory of the set of accessories of FIG. 3.

FIG. 7b is an exploded view of one accessory of the set of accessories of FIG. 3.

FIG. 8a is a side view of another embodiment of one accessory from a set of accessories.

FIG. 8b is a sectional illustration along line A-A of FIG. 8a.

FIG. 9 is a schematic representation of another embodiment.

FIG. 10a is a side view of an embodiment of an accessory.

FIG. 10b is an expanded view of a portion of FIG. 10a to show detail.

FIG. 10c is a partial sectional illustration along line A-A of FIG. 10a.

FIG. 11 is an illustration of the password recovery using the embodiment of FIG. 3.

FIG. 12a is a front view of an embodiment of one accessory from a set of accessories.

FIG. 12b is a partial sectional illustration along broken line A-A of FIG. 12a.

FIG. 12c is a partial sectional illustration along broken line B-B of FIG. 12a.

FIG. 13a is a front view of another embodiment of one accessory from a set of accessories.

FIG. 13b is a partial sectional illustration along broken line A-A of FIG. 13a.

FIG. 14 is an illustration of the use of the embodiment of FIG. 3.

FIG. 15 is perspective view of another embodiment of an accessory set of the invention.

FIG. 16 is a front view of the accessory set of the embodiment of FIG. 15.

FIG. 17 is a perspective view of an accessory of the embodiment of FIG. 15.

FIG. 18 is a perspective view of a bead of another embodiment.

FIG. 19 is a front view of a bead of another embodiment.

FIG. 20 is a perspective view of an operation of the embodiment of FIG. 15.

FIG. 21 is an illustration of the password recovery using the embodiment of FIG. 15.

FIG. 22 is a front view of another embodiment.

FIG. 23 is an illustration of the password recovery using the embodiment of FIG. 22.

FIG. 24 is an illustration of an alternative method of password recovery using the embodiment of FIG. 22.

### DETAILED DESCRIPTION

The invention includes a set of accessories and methods that generate and recover passcodes. Each accessory has a set of two or more symbols. The symbols may be digits that form an index string or figures that form a password string. In general, figures are displayed on one side of the accessory and digits are displayed on the opposite side of the accessory as associated pairs. When the figures across the set of accessories are aligned in a particular manner with respect to each other, the series of figures that appear across the surface of the accessories form a single password string. The accessories are aligned by dialing the digits on the reverse side of the figures according to a memory string. Dialing means to rotate aligned accessories with respect to one another so that the selected digits on the different accessories are close to one another. A memory string is a sequence of digits the user has memorized that may correspond to the number of accessories in the set. This memory string often corresponds to the digits in a month and day of the year, a particular year, an address, a partial phone number, or another personal identification number. Each accessory represents a single digit of the memory string. This intangible memory string is transcribed into a physical representation on the accessory set via the index string. The index string has a one-to-one correspondence between the digits in the memory string and the digits displayed on each accessory. Once the digits of the index string have been dialed and aligned on the respective accessories in the set, the user reveals the output symbol on the associated sides of the index digits. The sequence of output symbols creates the password string. Users may be instructed to further personalize the password string to create a website-friendly passcode.

The set of accessories 100 may take a variety of forms. One type of embodiment may take the form of a set of rings 200, a set of bracelets 300, a set of necklaces 400, or other similar accessory to accomplish similar password generation or recovery. Another type of embodiment may take the form of a single ring, a single bracelet, a single necklace, or other single accessory 101. Yet another type of embodiment may take the form of a watch 501.

For clarity, this document, when discussing a feature typical of a ring in a ring set 200, refers to the ring as 201, even though some details of the embodiments may differ. Additionally, this document, when discussing a feature typical of a bracelet in a bracelet set 300, refers to the bracelet as 301, even though some details of the embodiments may differ. Furthermore, this document, when discussing a feature typical of an accessory in an accessory set 100, refers to the accessory as 101, even though some details of the embodiments may differ.

The set of accessories 100 embodiment type insures better security and longevity of use. A set of four accessories 100 may be preferred as it corresponds to the number of digits in a month and day of the year, a particular year, an address, ora partial phone number. The configuration of four accessories 100 is also preferred to impart more security, longevity of use, and collectability. The set of four accessories 100 create many possible symbol entries and combinations, providing better security. This number of accessories 101 allows the user to collect new accessories 101 by switching out old accessories 101, or by adding new accessories 101 to further enhance security, longevity of use, and self-expression.

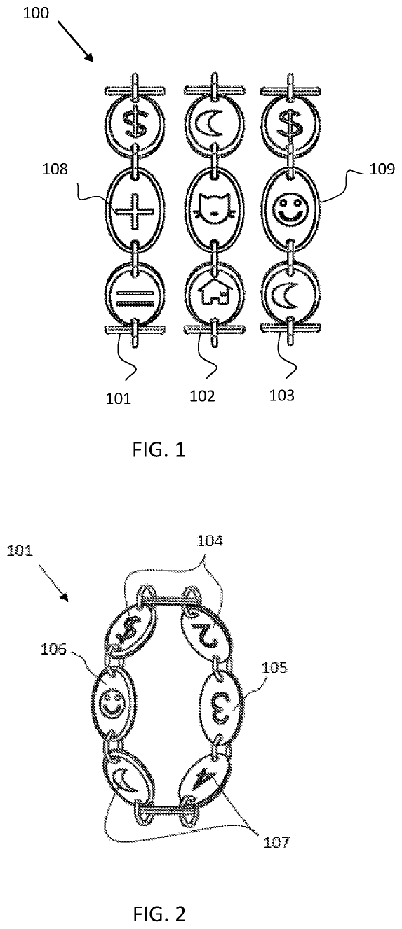

As visible in FIGS. 1 and 2, a set of accessories 100 may have beads 109 or surfaces that delineate multiple inner facets 105 and an equal number of matching, concentric, and parallel outer facets 106. The term “facet” 104 is not limited to a flat surface and may include curved or continuous surfaces with no abrupt change in slope. Such surfaces, which have continuous slopes are sometimes described mathematically as “smooth”. A facet 104 is a portion of the area on one side of the accessory 101. One embodiment of an accessory 101 includes ten inner facets 105 and ten outer facets 106. The configuration of ten inner facets 105 and ten outer facets 106 may be preferred because the number of single decimal digits correspond to the number of facets 104, aiding in the dialing of the memory string 134. In other embodiments, there may be fewer or more inner facets 105 of varying dimensions with unmatched dissimilar, parallel, and concentric outer facets 106.

Symbols 107 may be visible on both the inner facets 105 and the outer facets 106 of the accessory 101. Alternatively, symbols 107 may be visible on only one set of facets 104 while the other set of facets 104 remains concealed. Symbols 107 may be concealed on both the inner facets 105 and outer facets 106. These symbols 107 may include digits, letters, kanji, ascii, punctuation, pictures, emojis, icons, and original and licensed designs. Occasionally, a symbol 107 may be a blank symbol to increase the variety of possible passcodes 137 and passcode 137 strengths. Symbols 107 are made up of FIG. 108 or digits. In some embodiments, each FIG. 108 is associated with a particular digit as a recognizable pair.

In some embodiments, each accessory 101 of a set may have symbols 107 of a particular underlying theme like sports, animals, or food. Themes are preferred as they allow for self-expression of the user, enhance collectability of yet more accessories 101, and distinguish between each accessory 101 among the set. In other embodiments, there may be no particular theme to the symbols 107 on an accessory 101 and the symbols 107 may be arbitrarily displayed.

In one embodiment, at least one accessory 101 may have a theme of punctuation marks commonly used on a computer keyboard. Punctuation marks may be absent or dispersed among multiple symbols 107.

In some embodiments, each accessory 101 may have digits displayed on one set of facets 104 that are sequential. The digits may be labeled sequentially from zero to nine. This sequential numbering is preferred as it corresponds with the single decimal digits that form a memory string 134 and allows the user to more easily locate a digit. In other embodiments, the numbers may include two or more decimal digits. In some embodiments, the number of facet pairs (and hence digits) displayed may be limited to ten, corresponding to the number of decimal digits, or to twelve, corresponding to the number of months in a year or hours of a clock. This limitation advantageously reduces the manipulation necessary to recover a passcode and permits more legible symbols on an accessory of practical size.

In this instance, the term “display” defines a manufacturing or design method of showing a symbol 107 so that it appears legible on a surface. “Displaying” may involve some method of manufacturing including etching, embossing, casting, stamping, painting, printing, or inlay. The preferred method of “displaying” symbols 107 is some form of cutting or etching that is filled with contrasting color paint to better highlight the design of the symbol 107. This method is preferred for reasons of legibility, user comfort, and ease of manufacture and assembly. In other embodiments, the symbols 107 may be inlayed with seed beads, gems, or the like.

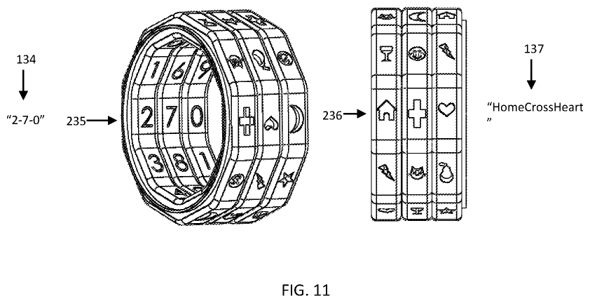

When the user is ready to generate a passcode 137, the user recalls a memory string 134 as diagrammed in FIG. 11. A memory string 134 is a sequence of digits which the user conceives in their mind that has the same number of digits as the number of accessories 101 in the set. The user utilizes the digits of the memory string 134 as indexes to select input symbols 107 on the facets 104 of the actual accessories 101. In doing so, the user associates the intangible memory string 134 with a physical representation on the device. The user locates the first digit of the memory string 134 by selecting the same digit as an index on the inner facet 105 of the first accessory 101 of the set. Next, the user may locate the second digit of the memory string 134 by selecting the same digit as a second index on the inner facet 105 of the second accessory 102 of the set. Next, the user may locate the third digit of the memory string 134 by selecting the same digit as a third index on the inner facet 105 of the third accessory 103 of the set. The user may continue this process until all digits of the memory string 134 have been represented as a physical index string 235 located on the aligned accessories 101 in the set. Once the user has dialed each accessory 101 of the set by positioning it so the digits of the index string 235 are aligned, the user will read the FIG. 108 on the reverse, parallel, associated outer facets 106. These FIG. 108 are the output symbols 107 that in the matching index string 235 order create the password string. The user may choose to read the password string from right to left or left to right, depending on preference.

The password string when read or written down, generates the majority of the newly formed passcode 137. The password string may be read in any language. An example of this process with the ring set 200 embodiment can be seen in \* MERGEFORMAT \R72Error! Reference source not found. and REF_Ref534382283 \h \* MERGEFORMAT Table 1.

TABLE 1
Ring Set Embodiment Passcode 137 Generation Example

| | | Index | |
|---|---|---|---|
| Ring Order | Memory String Digit | Digit | Output Symbol |
| 1 | 7 | 7 | [symbol] |
| 2 | 1 | 1 | [symbol] |
| 3 | 6 | 6 | [symbol] |

In this example, the chosen memory string 134 is 7-1-6. When the accessories 101 are dialed to the 7-1-6 sequence on the inner facets 105, the corresponding password string 236 has symbols: [symbol] . The password string 236 may be read in a variety of ways such as “MoonHomeHappy” or “moonHOMEh@ppy”, incorporating digits and punctuation in the place of lookalike characters. Additional operations will be recommended to fit typical website passcode 137 requirements, including the addition of digits and capitalization. Users may be instructed to incorporate some or all of the digits of their index string 235 in the password string 236. Users may do this by incorporating them throughout the password string 236 (ex: “Moon7Home1Happy6”) or appending them to the end or front of the password string 236 (ex: “716moonhomehappy” or “moonhomehappy716”). The user may combine other operations to further personalize the password string 236. Examples of further personalization includes capitalizing the first character of each symbol (ex: “MoonHomeHappy716”), capitalizing the characters of a particular theme (ex: “MOONHOMEhappy716”), transcribing each symbol into another language (ex: “LuneMaisonBonheur”), or summing the digits of their memory strings 134 together to append them in some manner to the password string 236 (ex: “MoonHomeHappy14”).

This personalization creates a usable passcode 137. The user may now enter this newly generated passcode 137 into a website login of their choice. The password string 236 may be recovered for future use when the user chooses to dial the accessories 100 together again to a particular configuration derived from a memory string 134. Multiple password strings 236 may be generated with the dialed memory string 134 varying per the user's discretion. When the accessory set 100 is not generating password strings 236, it may be worn as decoration with the accessories 101 randomly positioned relative to each other so that the password string 236 is not obvious to outside observers. This randomization process is preferred to prevent an outside observer from stealing sensitive password string 236 information. The password string 236 remains effectively recoverable but is concealed.

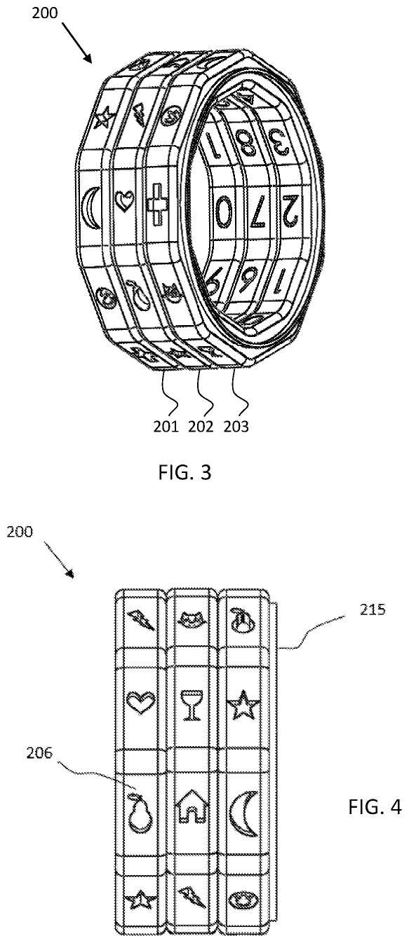

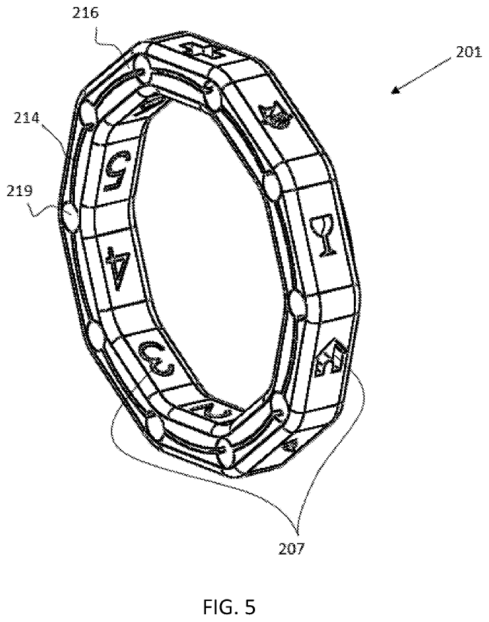

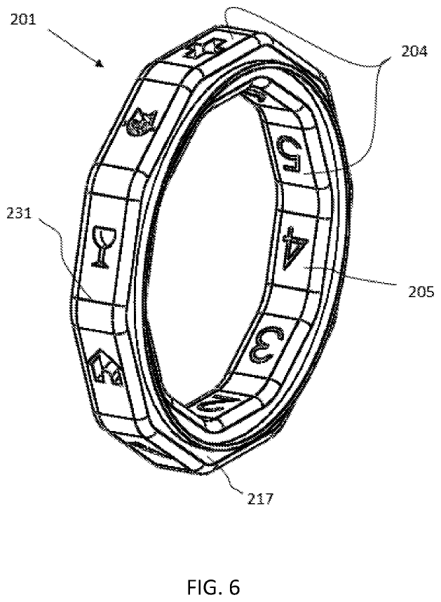

The following discussion describes an embodiment worn as a set of rings 200 as visible in FIGS. 3-8. This embodiment type may include a set of two or more of rings 201 that may align and connect with each other and may be worn together on a single finger or individually across multiple fingers.

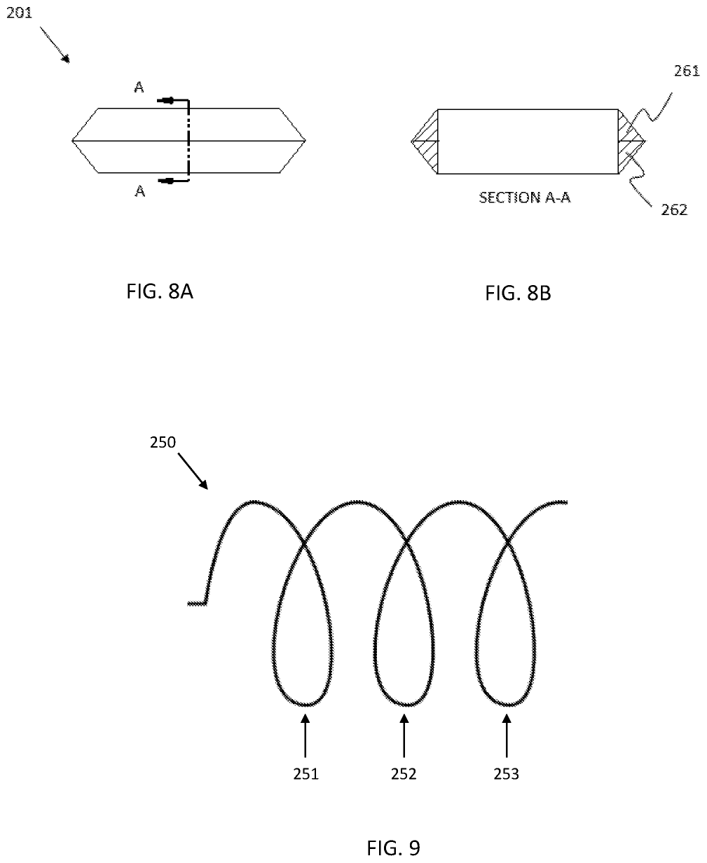

The rings 201 in the set may have a polygon tube with inner facets 205 and an equal number of matching, concentric, and parallel outer facets 206. The polygon tube may be polygonal on both the inside circumference and outside circumference. In other embodiments, the polygon tube may not be polygonal—just a circular tube with demarcations 231 to distinguish between facets 204. Though labeled as inner facets 205 and outer facets 206, the facets 204 are not restricted to be on the inside or outside or to be invisible or visible. In one embodiment (shown in FIGS. 8a and 8b), both facets 204, the first facet 261 and the second facet 262, are visible on the outside circumference of the ring 201 and may act as a matched or associated pair. FIG. 8a and FIG. 8b are shown only for the purpose of demonstrating an embodiment with two visible facets. Any other feature described in the specification may be attributed to this embodiment as is the case for all other embodiments.

In some embodiments, a ring 201 may include a polygon tube with multiple inner facets 205 and an equal number of matching concentric, and parallel outer facets 206. The following described embodiment includes exactly ten inner facets 205 and ten matching, concentric and parallel outer facets 206. In other embodiments, there may be fewer or more inner facets 205 of varying dimensions with unmatched dissimilar, parallel, and concentric outer facets 206. The inside circumference of the polygon tube may approximate commercial ring sizes. These approximate ring sizes may be used as a guide in embodiments worn as a set of rings 200.

In some embodiments, there may be either inner facets 205 or outer facets 206. The inner facets 205 and outer facets 206 of some embodiments may be approximately rectangular. The rectangular shape of the inner facets 205 and outer facets 206 is preferred for ease of manufacturing and to provide optimized space and visibility to displayed symbols 207. In other embodiments, the inner facets 205 and outer facets 206 may vary in shape to include circles, ovals, triangles, and other shapes. In yet other embodiments, the rings 201 may be made up of a set of beads with inner facets 205 and opposing and equal outer facets 206 connected by links.

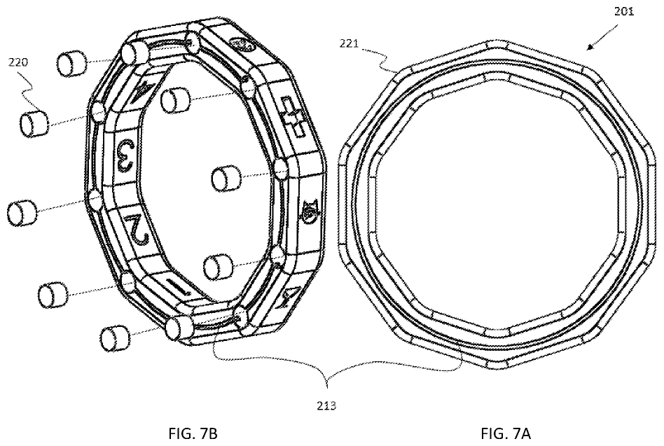

An embodiment may include a set of several similar rings 200 that can be temporarily attached to each other with a complementary track set 213. A track set 213 matches the track 214 of one ring 201 to the complementary rail 215 of an adjacent ring 202. Each ring 201 may have a track 214 on one surface, the alignment surface 216, and a rail 215 on the opposing parallel surface, the receiving surface 217 as shown in FIGS. 7a and 7b. As an example, the alignment surface 216 and the receiving surface 217 may be side-by-side edges of two adjacent rings, 201 and 202. When the complementary track 214 and rail 215 of adjacent rings 201 and 202 engage, the track set 213 allows angular movement between rings 201 and 202. The track set 213 can allow for an unlimited number of rings 201 to align together, including the third ring 203 shown in FIG. 3.

Although labeled a “rail” 215 and a “track” 214, these features may take different forms than the traditional boss of a rail 215 and blind cut of a track 214. The track set 213 need only include complementary features that engage and create a gliding angular connection. In other embodiments, the track set 213 may be locked in place, preventing detachment of individual rings 201.

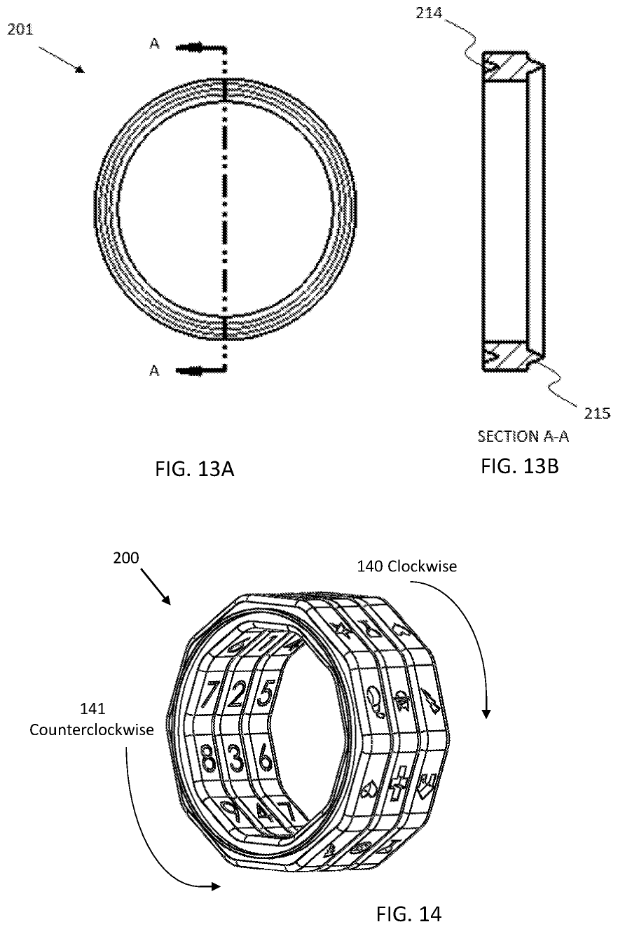

In other embodiments, the track set 213 may vary in shape to include a conical track set 213 (seen in FIGS. 13a and 13b), and others like a dovetail shape track set 213, a taper track set 213, a half moon or semicircle track set 213 or other design permutations that create a centered angular sliding connection.

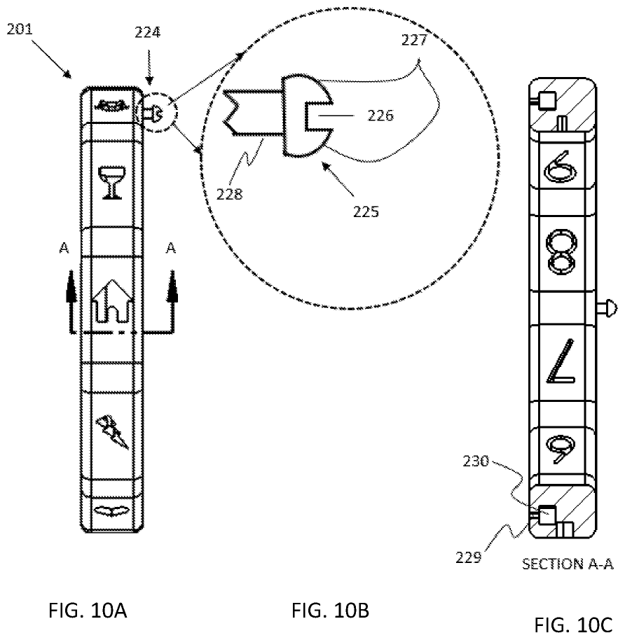

In other embodiments, the rail 215 is replaced with a pin 224 or series of pins 224 having a bulb 225 with a squeeze cut 226 which bisects the bulb 225 into flanges 227 (seen in FIGS. 10a, 10b, and 10c). The bulb 225 sits atop a shaft 228. The bulb 225 has a larger cross-sectional area than the shaft 228.

In the pin track set 213, the complementary track 214 has a primary channel 229 of equal or lesser depth and width to accommodate the shaft 228 of the pin 224 of the adjacent ring 202. The secondary channel 230 of the track 214 is of rounded shape to accommodate the shape of the bulb 225 of the adjacent ring 202 when sufficient pressure on the flanges 227 is exerted. The purpose of the squeeze cut 226 in the bulb 225 is to facilitate a connection to the secondary channel 230.

In other embodiments, there may be no track set 213 at all.

Some embodiments may be held together with magnets or pole pieces 220. Along the alignment surface 216, there may be circular magnet cavities 219. In other embodiments, the magnet cavities 219 may take a variety of shapes and may include rectangles, triangles, or other shapes. The preferred magnet cavity 219 shape is circular to accommodate the inlay of commercially produced magnets or pole pieces 220 as shown in FIGS. 7a and 7b. In addition, this shape is preferred because circular magnet cavities 219 and their inlayed magnets or pole pieces 220 better fit in the polygon tube and its vertices 221 along the centerline circumference of the ring 201.

The magnet cavities 219 may be arranged in a circular pattern in some embodiments, nestled into each vertex 221 of the polygon tube, concentrically along the centerline circumference of the ring 201. In other embodiments, the magnet cavities 219 may be located offset from the vertices 221 instead of concentric to the vertices 221.

The magnet cavities 219 may be blind cut, leaving the inlayed magnets or pole pieces 220 flush with the alignment surface 216. This blind cut is preferred to preclude snagging, to ensure user comfort, and to reduce manufacturing costs. In other embodiments, the magnet cavities 219 may be through holes to accommodate a larger depth of magnet or pole piece 220. In still other embodiments, the magnets or pole pieces 220 may be raised and fit into shallower magnet cavities 219. In this embodiment, the raised magnets or pole pieces 220 may act as bumps 222 along with complimentary detents 223 to aid in cogging described in following paragraphs.

Magnets or pole pieces 220 in some embodiments may be press-fit into magnet cavities 219. Alternatively, the magnets or pole pieces 220 may be adhered to the magnet cavities 219 with adhesive, shrink wrap, a combination of all these methods, or other suitable manufacturing or assembly processes.

Magnets or pole pieces 220 may provide connection and cogging. “Cogging” is defined as discrete incremental movements along a circular path. The full rotation of the ring 201 along an adjacent similar ring 202 is divided into a number of increments that correspond to the number of vertices 221 of the polygon tube. In other embodiments, the number of increments may not be the same as the number of inner facets 205 or outer facets 206. Rotation applied by the user to the rings 201 will allow the magnets or pole pieces 220 of one ring 201 to exert a magnetic force against the magnets or pole pieces 220 on the adjacent ring 202. These magnets or pole pieces 220 will engage with each other and resist each other, producing a discrete incremental cogging movement or resistance as the magnets 220 of one ring 201 pass the pole pieces 220 of another.

One embodiment may have five magnets or pole pieces 220 on a single ring 201 and two magnets or pole pieces 220 on an adjacent ring 202. The five magnets or pole pieces 220 may be evenly distributed around the centerline circumference. The two magnets or pole pieces 220 of the connecting ring 202 may be separated by an even number of facet 204 positions, such as diametrically opposed. When the rings 201 and 202 are rotated with respect to each other, the magnets or pole pieces 220 of each ring 201 and 202 may engage and produce a cogging movement of ten even and discrete increments (as seen in FIG. 14). In other embodiments, the increments may be uneven. The rotation can be applied in either clockwise 140 and counterclockwise 141 directions. This combination of magnets or pole pieces 220 arrayed on adjacent rings 201 and 202 is preferred as it requires fewer magnets or pole pieces 220, reducing manufacturing and supply costs, reducing the weight of the rings 201, and reducing user discomfort.

In other embodiments, there may be varying multiples of magnets or pole pieces 220 on alternating rings 201 and 202, creating different increments of cogging. There may be the same number of magnets or pole pieces 220 on each ring 201 and 202. The magnets or pole pieces 220 may not be used at all or the body of the ring 201 itself may be made magnetic in still other embodiments.

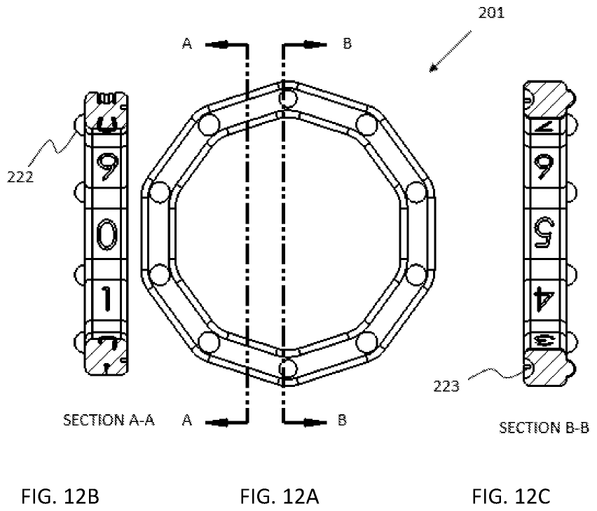

FIGS. 12a, 12b, and 12c illustrate another method of cogging. In some embodiments, in place of magnets or pole pieces 220, cogging may be achieved through a set of bumps 222 on the alignment surface 216, that engage with a matching or complementary set of detents 223 on the receiving surface 217 of an adjoining adjacent ring 202 All other features of the ring set 200 may still be present on the alternate cogging method embodiment illustrated in these figures. In some embodiments, the bumps 222 and detents 223 may be evenly placed and equal to the number of inner facets 205 or outer facets 206. The bumps 222 and detents 223 may be arranged in a circular pattern in some embodiments, nestled into each vertex 221 of the polygon tube, concentrically along the centerline circumference, one bump 222 or one detent 223 for each vertex 221. In other embodiments, the bumps 222 and detents 223 may be located offset from the vertices 221 instead of concentric to the vertices 221. Cogging movement may be achieved in a similar manner to the magnet or pole piece 220 configuration without magnetic resistance or force. Instead, the bumps 222 and detents 223 will engage mechanically when rotated. In these instances, the number of bumps 222 should equal the number of detents 223.

Most cut edges of the polygon tube may be rounded, filleted, or chamfered to prevent snagging and provide overall comfort.

When the set of four rings 201 are attached and gliding angularly along each other, the cogging movements of the rings 201 and 202 may allow the outer facets 206 of each ring 201 to line up evenly and coplanar to each other. Consequently, the respective inner facets 205 of one ring 201 may line up coplanar to the inner facets 205 of its neighboring rings 202. In other embodiments, the outer facets 206 and the inner facets 205 of one ring 201 may not line up evenly or coplanar to the respective outer facets 206 and inner facets 205 of the adjacent ring 202.

When ready to generate a passcode 137, the user may remove the set of rings 200 or put them all on the same finger. The user may attach the rings 201 together, snapping the rail 215 of one ring 201 to the track 214 of an adjacent ring 202.

The user then recalls a memory string 134, as diagrammed in FIG. 11. The user locates the first digit of the memory string 134 on the first ring 201 by selecting the same digit as an index on the inner facet 205 of the first ring 201 of the set. Next, the user may locate the second digit of the memory string 134 by selecting the same digit as a second index on the inner facet 205 of the second ring 202 of the set. The user may continue this process until all digits of the memory string 134 have been represented as a physical index string 235 located on the aligned rings 201 in the set. Once the user has dialed each ring 201 of the set by positioning it so the digits of the index string 235 are aligned, the user will read the FIG. 208 on the reverse, parallel, associated outer facets 106. These FIG. 208 are the output symbols 207 that in the matching index string 235 sequence create the password string 236. The user may choose to read the password string 236 from right to left or left to right, depending on preference. The example shown in FIG. 11 uses three digits and three rings, but the process is equally applicable to fewer or more rings 201 and respective digits.

The password string 236 when read or written down, generates the majority of the newly formed passcode 137. With a few more instructions described previously, the user may now enter this newly generated passcode 137 into a website login of their choice. This password string 236 is recoverable for future use when the user chooses to cog and dial the set of rings 200 together again using that same memory string 134. Multiple password strings 236 may be generated with different memory strings 134. When the ring set 200 is not generating password strings 236, it may be worn as decoration with the rings 201 randomly positioned. The password string 236 remains effectively recoverable but concealed.

Another type of embodiment set is the winding set embodiment 250. This embodiment set may be used around the finger or multiple fingers similar to the ring set 200 type embodiment or around the wrist or any human appendage. In the winding set embodiment 250, there may be a single chain or continuous string that wraps several times around a finger or multiple fingers (as seen in FIG. 9). The password string 236 is generated in the same manner as the separated ring set embodiment 200 with each winding acting as a single accessory 101 and representing a single digit in the memory string 134. The first winding 251, second winding 252, third winding 253, and any additional windings may act as a set.

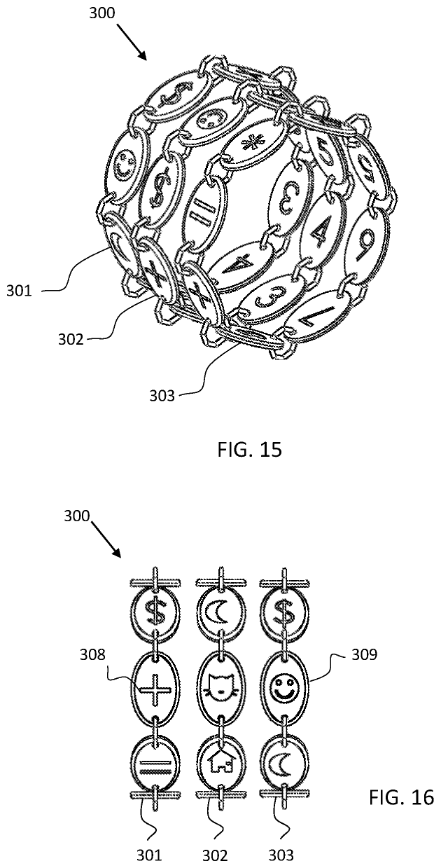

The following discussion describes an embodiment that may be worn as a set of bracelets 300 (as seen in FIG. 15 and FIG. 16). An embodiment may include a set of two or more bracelets 301 that may be worn together on a single wrist or ankle or individually across many wrists or ankles. The inside circumference of the bracelet 301 may approximate commercial bracelet or anklet sizes.

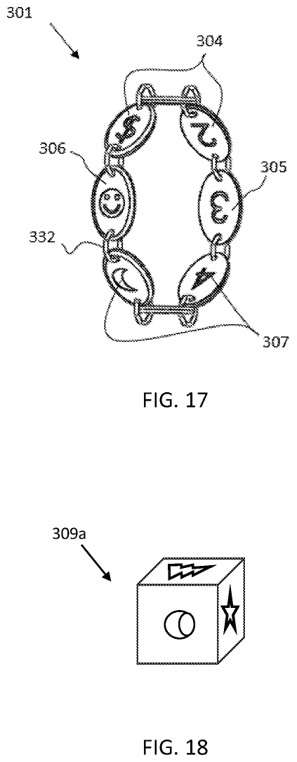

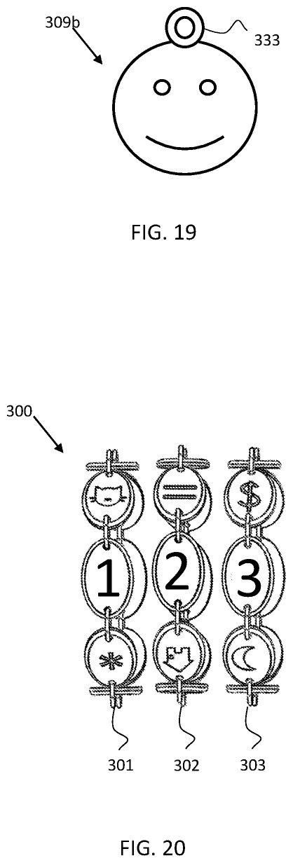

In one embodiment, beads 309 may delineate the facets 304. The beads 309 can be any of a number of bead types including the pierced bead 309a of FIG. 18, the charm bead 309b of FIG. 19, or a linked bead such as 309 of FIG. 16. The beads 309 may be flat disks with one inner facet 305 and one opposing, parallel, equal outer facet 306. Flat disks are preferred to provide greater ease of manufacture and assembly, and to optimize space and visibility of displayed symbols 307. In other embodiments, the beads 309 may have more than two sides or facets 304 (as seen in FIG. 18). In an embodiment such as this, there may exist a through hole through which a string may be threaded. In such an embodiment, the beads 309 may have more than one FIG. 308 and associated digit. In still other embodiments, the beads 309 may be round. The beads 309 may take the shape of particular symbol 307 in a kind of charm in other embodiments (as seen in FIG. 19). The loop 333 seen in FIG. 19 may be used to attach one bead 309 to another directly or with the addition of a string or link 332, as seen in FIG. 17. In still other embodiments, the beads 309 may take a variety of shapes such as ovals, diamonds, squares, prisms, or triangles.

In one embodiment, the beads 309 may be connected by links 332. The links 332 may be made up of chain or wire or other material that attach beads 309 to each other. In some embodiments, the links 332 allow the beads 309 to lay flat while in other embodiments, the links 332 allow the beads 309 to rotate freely. In still other embodiments, the bracelet 301 is all of a piece or a continuous band having no abrupt change in slope with demarcations to delineate between beads 309 or inner facets 305 or outer facets 306. In some embodiments, the bracelet 301 is a polygon tube and operates in a similar manner as the ring set embodiment 200 described above.

The beads 309 may have one or more holes or loops 333 (as seen in FIG. 19) that allow connection to other beads 309. In some embodiments, there are no holes or loops 333 and the beads may connect by other methods including wire wrapping, welding, or magnets.

One embodiment of the bead 309 may have a single hole or loop 333 that allows the bead 309 to dangle off of the links 332 like a charm or tag (as seen in FIG. 19). An embodiment of the bead 309 may have two holes or loops 333 diametrically opposed on the beads 309. This diametric hole 336 configuration is preferred to allow the beads 309 to lay flat with the inner facet 305 close to the user's body and the opposing outer facets 306 exposed. This configuration provides better security that may prevent an outside observer from seeing both sides of the beads 309 and ascertaining potential password strings 336. In other embodiments, the beads 309 may have more than two holes or loops 333. A clasp may create temporary closure for the bracelet 301 in some embodiments.

On one embodiment, symbols 307 may be displayed on each of the inner facets 305 and outer facets 306. The symbols 307 may be digits that form the memory string 134 or FIG. 308 that form the password string 336.

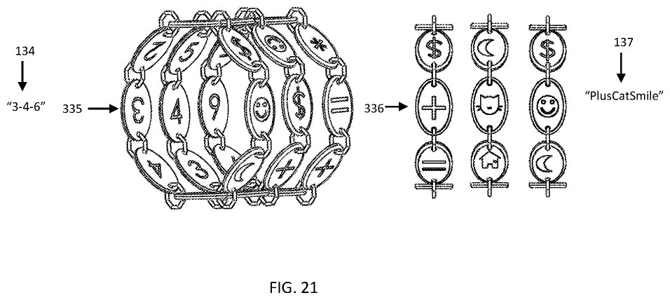

When ready to generate a passcode 137, the user recalls a memory string 134 that corresponds to a month and day of a year, a year, a partial phone number, an address, or another personal identification number, as diagrammed in FIG. 21. Each bracelet 301 may correspond to a digit in the memory string 134. The user locates the first digit of the memory string 134 by selecting the same digit as an index on the inner facet 305 of the designated “First” bracelet 301. Then the user locates the second digit of the memory string 134 by selecting the same digit as a second index on the inner facet 305 of the designated “Second” adjacent bracelet 302. Then the user locates the third digit of the memory string 134 by selecting the same digit as a third index on the inner facet 305 of the designated “Third” adjacent bracelet 303. The user may continue this process until all digits of the memory string 134 have been represented as a physical index string 335 located on the aligned bracelets 301 in the set, each bracelet 301 representing a single digit.

A variety of methods may be used to distinguish the order of the set of bracelets 300 that the user should read from. In one embodiment, a single bead 309 of each bracelet 301 may flipped with the number showing. To distinguish the first bracelet 301 to be read, the bead 309 with the digit “1” label will be displayed on the outer facet 306 instead of the inner facet 305. On the second bracelet 302 to be read, the bead 309 with the digit “2” label will be displayed on the outer facet 306 instead of the inner facet 305 (as seen in FIG. 20).

In other embodiments, the order of the set of bracelets 300 to be read may be distinguished by a different material, color, shape, style, theme of symbols 307, or other method across the bracelet set 300. In still other embodiments, no delineation between bracelets for order to be read may be needed. In some embodiments, the bracelets 301 may be attached to each other or worn sequentially to inform the order of the FIG. 308 reading, much like the embodiment worn as a ring set 200 described previously.

Once the user has dialed each bracelet 301 of the set by positioning it so the digits of the index string 335 are aligned, the user will read the FIG. 308 on the reverse, parallel, associated outer facets 106. These FIG. 308 are the output symbols 307 that in the matching index string 335 sequence create the password string 336. The user may choose to read the password string 336 from right to left or left to right, depending on preference.

The password string 336 when read or written down, generates the majority of the newly formed passcode 137. An example of this process can be seen in FIG. 21 and \* MERGEFORMAT Table 2.

TABLE 2
Bracelet Set Embodiment Passcode 137 Generation Example

| Bracelet | Memory String | Index | Output |
|---|---|---|---|
| Order | Digit | Digit | Symbol |
| 1 | 2 | 2 | [symbol] |
| 2 | 7 | 7 | [symbol] |
| 3 | 3 | 3 | [symbol] |

In this example, the chosen memory string 134 is 2-7-3. When the bracelet set 300 is dialed to the 2-7-3 sequence of the memory string 134, the password string 336 reads: [symbol] The final passcode 137 may be read in a variety of ways such as “EqualCrossSmile” or “equa!CROSSsmi1e”, incorporating digits and punctuation in the place of lookalike characters.

Additional operations will be recommended to fit typical website passcode 137 requirements, including the addition of digits and capitalization. The example shown in FIG. 21 uses a three-digit memory string 134 and set of three bracelets 300, but the process is equally applicable to fewer or more bracelets 301 and respective memory string 134 lengths. With a few more instructions described previously, the user may now enter this newly generated passcode 137 into a website login of their choice. Note that, in a memory string 134 that repeats the same digit, like 2-8-8, a single digit (8) in the memory string 134 may be associated to different and unrelated FIG. 308 in a password string 336 because each bracelet 301 (or other accessory 101) has an independent set of FIG. 308 associated with its digits.

An embodiment worn as a set of necklaces may be constructed in a similar fashion to the set of bracelets 300 type of embodiment or set of rings 200 type of embodiment with a longer chain, links, or inner facets and outer facets to fit the neck. Passcode 137 generation and recovery may proceed in the same manner as the ring set 200 or bracelet set 300 type of embodiments.

A second type of embodiment has only a single accessory 101 instead of a set. The invention may be a single ring, a single bracelet, or a single necklace. The password string 136 may be generated by referring to the digits of the memory string 134 multiple times on the same accessory 101. In such embodiments, password strings 136 will include the same FIG. 108 for each repetition of a digit in a memory string 134. The passcode 137 derived from such an embodiment may be advantageously varied by any of a number of methods, such as changing the language or capitalization of the second instance of a FIG. 108 in a password string 136. Although this method of passcode 137 generation leads to less complex passcodes 137, it requires fewer parts.

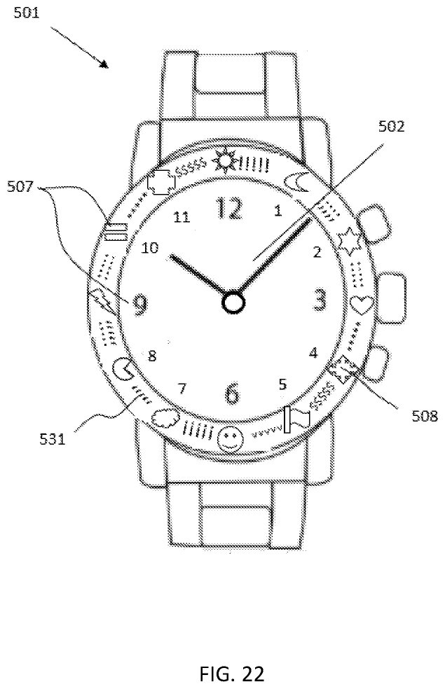

The following discussion describes an embodiment that may be worn as a watch 501. The watch 501 may have an analog style watch face 502 (as seen in FIG. 22). The watch face 502 may display digits at each minute or hour. In other embodiments, the watch face 502 may display tick marks or other demarcations 531 to denote divisions of time into hours, minutes, seconds or a combination thereof. The watch 501 may be worn on the wrist and its inside circumference may approximate commercial watch band sizes. In some embodiments, the watch 501 is worn as a pendant, a key chain, a broach, or another accessory 101.

Symbols 507 may be displayed at some or all demarcations 531. The symbols 507 may be displayed adjacent the hour demarcations 531 to allow the user to associate a particular symbol 507 with a particular demarcation 531. This configuration is preferred for ease of password string 536 generation, and to avoid overcrowding and thus illegibility. In other embodiments, the symbols 507 may be displayed for every minute demarcation 531.

The demarcations 531 may take a variety of forms including, squares, hashes, dashes, dots, or other styles. Some or all existing demarcation 531 may take the form of common keyboard punctuation marks. The ten demarcations 531 of minutes between each hour may be a set of one particular punctuation mark (as seen in FIG. 22). This punctuation configuration is preferred for ease of passcode 137 generation that will be described in following paragraphs.

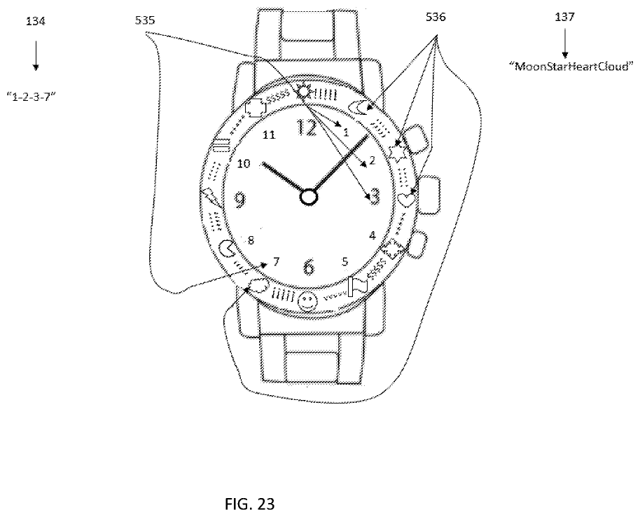

When ready to generate a passcode 137, the user recalls a memory string 134 that corresponds to a day and month of the year, a year, a partial phone number, an address, or another personal identification number, as diagrammed in FIG. 23. The user may locate on the watch face 502 the hour demarcation 531 that corresponds to the first digit of the memory string 134 by selecting the same digit as an index. Next, the user records or remembers the associated FIG. 508 in written language and records or remembers the associated punctuation mark on the adjacent hour or minute demarcations 531. The user repeats this process with the remaining digits of the memory string 134 until the full index string 535 is formed (as seen in FIG. 23 and \* MERGEFORMAT Table 3). The index string 535 is used to find the associated FIG. 508 that form the password string 536: [symbol] . The final passcode 137 may read “MoonStarHeartCloud.” The final passcode 137 may be constructed in a variety of ways previously described in the bracelet set embodiment 300. The use of varied capitalization, special characters, and added digits may further personalize the passcode 137.

TABLE 3
Watch Embodiment Passcode 137 Generation Example

| Watch | Memory String | Index | Output |
|---|---|---|---|
| Order | Digit | Digit | Symbol |
| 1 | 1 | 1 | [symbol] |
| 2 | 2 | 2 | [symbol] |
| 3 | 3 | 3 | [symbol] |
| 4 | 7 | 7 | [symbol] |

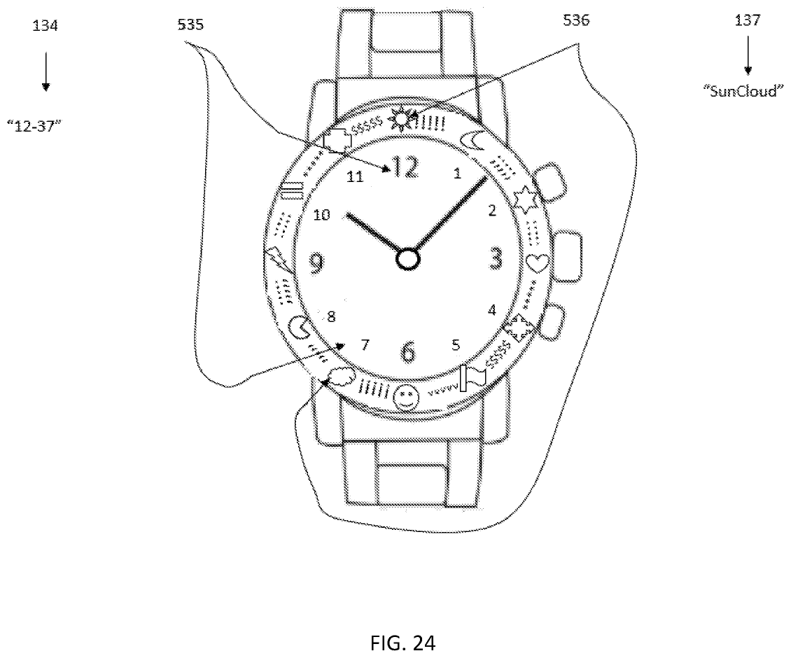

The example in FIG. 23 and \* MERGEFORMAT Table 3 shows a four-digit memory string 134, but the process can be applied to shorter or longer memory strings 134. In some embodiments, the user may locate the index string 535 by digit pairs and look for the FIG. 508 adjacent the minute demarcation 531 as diagrammed in FIG. 24. A memory string 134 of 1-2-3-7 may be broken up into digit pairs of ‘12’ and ‘37’. The user may locate those digit pairs as an index string 535 on the minute or hour demarcations 531 to generate a password string 536 (as seen in FIG. 24 and REF_Ref534382103 \h \* MERGEFORMAT Table 4): [symbol] . The final passcode 137 may be a variety of ways previously described and may approximate “StarCloud.” The use of varied capitalization, special characters, and added digits may further personalize the passcode 137.

TABLE 4
Watch Embodiment Passcode 137 Generation Example

| Watch | Memory String | Index | Output |
|---|---|---|---|
| Order | Digit | Digit | Symbol |
| 1 | 12 | 12 | [symbol] |
| 2 | 37 | 37 | [symbol] |

In the watch 501 embodiment, the number zero may not be represented on the watch face 502 or memory string 134. In some embodiments the number zero is represented by the background theme of the watch face 502 (Example: Flowers, or Sunrise), by an extra zero and associated FIG. 508 floating on the watch face 502, or by some other method.

With a few more instructions described in previous embodiments, the user may now enter this newly generated passcode 137 into a website login of their choice. The password string 536 will be recovered for future use when the user chooses to locate the FIG. 508 and demarcation 531 again to a particular configuration based on a memory string 134. Multiple password strings 536 may be generated with the selected memory string 134 varying per the user's discretion. When the watch 501 is not generating password strings 536, it may be worn as decoration or to keep time without the password string 536 being revealed to outside observers.

The embodiments described herein are referred in the specification as “one embodiment,” “an embodiment,” “an example embodiment,” etc. These references indicate that the embodiment(s) described can include a particular feature, structure, or characteristic, but every embodiment does not necessarily include every described feature, structure, or characteristic. Further, when a particular feature, structure, or characteristic is described in connection with an embodiment, such feature, structure, or characteristic in may also be used in connection with other embodiments whether or not explicitly described. Further, where specific examples are given, the skilled practitioner may understand the particular examples as providing particular benefits such that the invention as illustratively disclosed herein suitably may be practiced in the absence of any element which is not specifically disclosed herein or within that particular example.

It will be apparent to those of ordinary skill in the art that many modifications and variations of the described embodiments are possible in the light of the above teachings without departing from the principles and concepts of the disclosure as set forth in the claims.

Although the present disclosure describes certain exemplary embodiments, it is to be understood that such disclosure is purely illustrative and is not to be interpreted as limiting. Consequently, without departing from the spirit and scope of the disclosure, various alterations, modifications, and/or alternative applications of the disclosure will, no doubt, be suggested to those skilled in the art after having read the preceding disclosure. Accordingly, it is intended that the following claims be interpreted as encompassing all alterations, modifications, or alternative applications as fall within the true spirit and scope of the disclosure.

1. A device comprising:
a first wearable and a second wearable, the first and second wearable each including:
an aperture sized to accommodate a part of a person;
a set of output surfaces, each output surface displaying an output symbol;
a set of index surfaces, each index surface displaying an index symbol, each index surface associated with one of the set of output surfaces;
an alignment surface; and
a receiving surface,
wherein the alignment surface of the first wearable is configured to engage the receiving surface of the second wearable.

2. The device of claim 1, wherein the first wearable further includes a cogging feature.

3. The device of claim 2, wherein the cogging feature has a magnet, a pole piece, a groove, or a boss.

4. The device of claim 3 wherein the second wearable includes a second cogging feature complementing the first cogging feature.

5. The device of claim 1, wherein when the device is worn by a person, one of the set of index symbols or the set of output symbols are obscured.

6. The device of claim 1, wherein the first wearable further includes an ordering feature having one or more of a symbol, a color, a material, a theme, or a shape not present in the second wearable.

7. The device of claim 1, wherein each of the index surfaces is not continuous with its associated output surface.

8. The device of claim 1, further comprising: a third wearable and a fourth wearable, the third wearable displaying a third set of output symbols and the fourth wearable displaying a fourth set of output symbols, wherein the third set of output symbols is different from the fourth set of output symbols.

9. The device of claim 1, wherein the index symbol is a digit.

10. A device comprising:
a first wearable and a second wearable, each wearable including:
a plurality of links, the links forming a looped chain;
a plurality of plates, each plate directly connected to a first link of the plurality of links, each plate displaying an output symbol, and each plate having a surface displaying a unique index symbol.

11. The device of claim 10, wherein each plate is further directly connected to a second link of the plurality of links.

12. The device of claim 11, wherein each plate is configured to rotate with respect to another plate of the plurality of plates.

13. The device of claim 10, wherein the first wearable includes an ordering feature having one or more of a symbol, a color, a material, a theme, or a shape not present in the second wearable.

14. The device of claim 10, further comprising: a third wearable and a fourth wearable, the third wearable displaying a third set of output symbols and the fourth wearable displaying a fourth set of output symbols.

15. The device of claim 10, wherein the unique index symbols comprise a set of index symbols, including digits zero through nine, and wherein the set of index symbols are common to each wearable.

16. A method of recovering a passcode using a device comprising a set of wearables, each wearable including a plurality of index symbols and a plurality of output symbols, each index symbol associated to one of the output symbols, the method comprising:
a) recalling a memory string including a sequence of recalled symbols;
b) selecting a recalled symbol of the sequence of recalled symbols;
c) for each selected recalled symbol:
i. selecting a wearable of the set of wearables;
ii. locating the index symbol of the selected wearable corresponding to the selected recalled symbol;
iii. determining the output symbol associated with the located index symbol; and
iv. concatenating the determined output symbol to a password string;
d) repeating steps b) and c) for each recalled symbol of the sequence of the recalled symbols;
e) translating each output symbol of the password string to a natural language character string; and
f) concatenating each translated character string to recover the passcode.

17. The method of claim 16, wherein the set of wearables include a first wearable and a second wearable, the first wearable having an alignment surface, the second wearable having a receiving surface, the alignment surface configured to engage the receiving surface, wherein the method further comprises engaging the alignment surface to the receiving surface.

18. The method of claim 17, wherein the alignment surface includes a first cogging feature and the receiving surface includes a second cogging feature complementary to the first cogging feature, the method further comprising rotating the first wearable with respect to the second wearable along the engaged surfaces to align an index symbol of the first wearable proximate an index symbol of the second wearable.

19. The method of claim 16, wherein each wearable of the set of wearables includes an ordering feature and the steps of selecting a wearable of the set of wearables includes referring to the ordering feature.

20. The method of claim 16, wherein the set of wearables comprises a multiturn winding.
